(19) United States
(12) Patent Application Publication
(10) Pub. No.: US 2010/0269087 A1
(43) Pub. Date: Oct. 21, 2010

(54) SOFTWARE TOOLS USAGE FRAMEWORK BASED ON TOOLS EFFECTIVE USAGE INDEX

(76) Inventor: VIDYA ABHIJIT KABRA, Bangalore (IN)

Correspondence Address: GLOBAL IP SERVICES, PLLC, 10 CRESTWOOD LANE, NASHUA, NH, 03062, US

(21) Appl. No.: 12/426,299

(22) Filed: Apr. 20, 2009

(51) Int. Cl. G06F 9/44

(52) U.S. Cl. 717/101

(57) ABSTRACT

A method and apparatus for effectively using software tools employed in a software development project are disclosed. In one embodiment, a method, implemented in a computing device, for effectively using software tools for a software development project includes displaying a tools plan view for a software development project having a plurality of tools categories associated with the software development project on a display of the computing device, wherein the plurality of tools categories are assigned with their respective weightages and natures. The method also includes generating a planned tools effective usage index (TEUI) on the display in response to a receipt of tools plan data and tools review data associated with the software development project. The method further includes generating an actual TEUI on the display in response to a receipt of tools usage data and tools assessment data associated with the software development project.

### FIELD OF TECHNOLOGY

Embodiments of the present invention relate to the field of computer software. More particularly, embodiments of the present invention relate to software development.

### BACKGROUND

A software service company may go through several software development stages of requirement analysis, design, development, and test when a software development project is awarded by a client company. Software tools may be programs or applications that software developers of the software development project use during the software development stages to meet the objectives of the software development project. Accordingly, once the software development project is initiated, a number of software tools may be bought or licensed by the software service company.

However, some of the software tools may not be used effectively due the software developers' unfamiliarity with some of the software tools or oversight by the software developers in using some of available features of the software tools while carrying out the software development project. As a result, the software development project may have issues with quality of its work products and/or underuse of its available resources, namely the software tools.

### SUMMARY

A method and apparatus of effectively using software tools for a software development project are disclosed. In one aspect, a method of effectively using software tools for a software development project includes displaying a tools plan view for a software development project having a plurality of tools categories associated with the software development project on a display of a computing device, wherein the plurality of tools categories are assigned with their respective weightages and natures.

The method also includes generating a planned tools effective usage index (TEUI) on the display in response to a receipt of tools plan data and tools review data associated with the software development project. The method further includes generating an actual TEUI on the display in response to a receipt of tools usage data and tools assessment data associated with the software development project, wherein the tools plan data and the tools usage data are logged in by a project manager authenticated for the software development project and the tools review data and the tools assessment data are logged in by a tools manager authenticated for the software development project.

In another aspect, a computer network of nodes includes a server node and client nodes, when the server node requested by the client nodes for a service, causes the server node to perform the method described above.

In yet another aspect, an apparatus for effectively using software tools for a software development project includes a processor and a memory for temporarily storing a set of instructions, when executed by the processor, causes the processor to perform the method described above.

The methods, apparatuses and systems disclosed herein may be implemented in any means for achieving various aspects, and other features will be apparent from the accompanying drawings and from the detailed description that follow.

### BRIEF DESCRIPTION OF THE DRAWINGS

Various preferred embodiments are described herein with reference to the drawings, wherein:

FIG. 1 illustrates an exemplary computing device operable for practicing various embodiments of the present invention;

FIG. 2 illustrates an exemplary network environment operable for practicing various embodiments of the present invention;

FIGS. 3, 5, 6, and 7 illustrate an exemplary tools plan view, according to one embodiment;

FIG. 4 illustrates exemplary software engineering criteria for tools categories, according to one embodiment;

FIGS. 8A, 8B, 9A, 9B, and 10 illustrate an exemplary tools usage view, according to one embodiment; and

FIG. 11 is a process flow chart of an exemplary method of effectively using software tools employed in a software development project, according to one embodiment.

The drawings described herein are for illustration purposes only and are not intended to limit the scope of the present disclosure in any way.

### DETAILED DESCRIPTION

A method and apparatus of effectively using software tools for a software development project are disclosed. In this invention, a framework for effective use of software tools is proposed, where the framework may be realized by a standalone application or an application serviced via a network. To meet a client's requirements for a software development project, the framework proposes tools categories associated with the project, where each tools category is divided into a number of software engineering criteria. Then, each software engineering criteria is assigned with a corresponding weightage according to its importance. As a project manager for the software development project plans mandatory software tools by entering corresponding data to the framework, the framework generates a planned tools effective usage index (TEUI). In addition, as the software tools are used by members of the project once they are approved by a tools manager assigned for the project, an actual TEUI is generated based on tools usage data entered by the project manager and tools assessment data entered by the tools manager.

Thus, the framework promotes collaboration between the project manger, which represents the software development team and the tools manager, which represents tools experts. Additionally, this invention provides continuous assessment of the tools use by the members of the software development project and quality assurance of products generated by the software development project. Particularly, the tools effective usage index (TEUI), which is generated by the framework based on the user input, can be utilized to assess the effectiveness of the software tools employed in the project and improve the quality of end product(s).

In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The terms “computing device” and “computer” are used interchangeably throughout the document. Also, the terms ‘software tool’ and ‘tool’ are used interchangeably throughout the document. In the document, the term “tool effective usage index (TEUI) refers to a metric to assess how effectively software tools are used in a software development project against software engineering criteria available against each tools category. Further, the term “project manager” refers to a field manager overseeing a software development project, and the term “technical manager” refers to one whom project managers report to. Moreover, the term “tools manager” refers to an expert in tools usage.

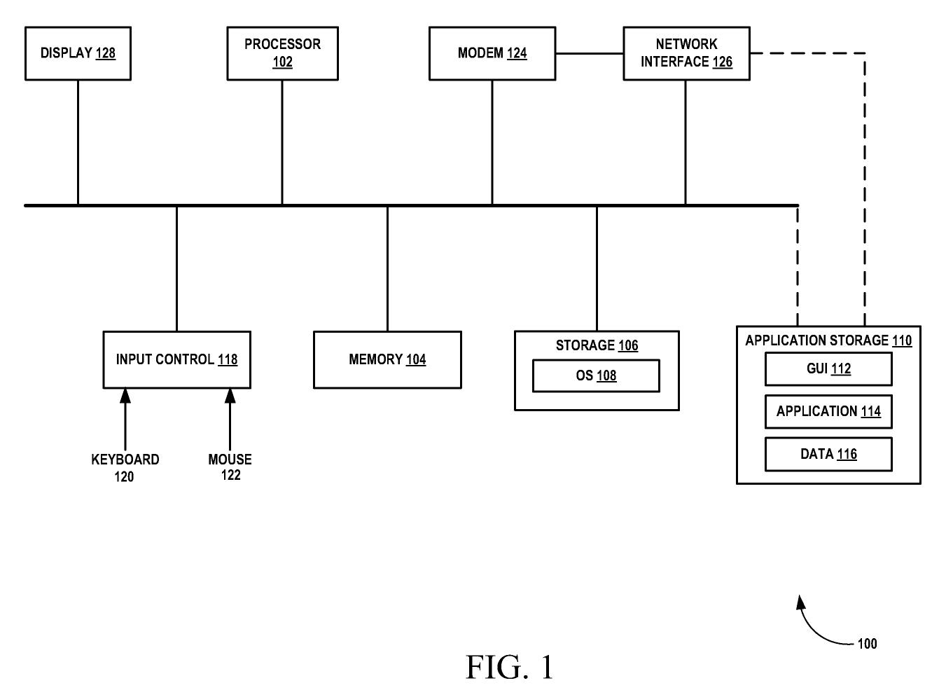

FIG. 1 illustrates an exemplary computing device 100 operable for practicing various embodiments of the present invention. One of ordinary skill in the art will appreciate that the computing device 100 is intended to be illustrative and not limiting of the present invention. The computing device 100 may take many forms, including but not limited to a workstation, server, network computer, quantum computer, optical computer, bio-computer, Internet appliance, mobile device, pager, tablet computer, and the like.

The computing device 100 may be an electronic device and includes a processor 102, a memory 104, a system storage 106 storing an operating system 108, an application storage 110 storing a graphical user interface (GUI) 112, an application 114, data 116, an input control 118 for a keyboard 120 and a mouse 122, a modem 124, a network interface 126, a display 128, etc. The processor 102 controls each component of the computing device 100 for effectively using software tools for a software development project. The memory 104 temporarily stores instructions and data and provides the stored instructions and data to the processor 102 so that the processor 102 operates the computing device 100 to effectively use the software tools for the software development project.

The system storage 106 includes code for the OS 108 of the computing device 100. The application storage 110 includes code for the application 114 running on the OS 108 which effectively uses the software tools and the data 116 associated with the software tools of the software development project. In one example implementation, the system storage 106 and the application storage 110 may be implemented using a single storage. In another example implementation, the GUI 112, the application 114, and the data 116 may be stored in different storage devices.

The input control 118 may interface with the keyboard 120, the mouse 122, and other input devices. The computing device 100 may receive, through the input control 118, input data necessary for effectively using the software tools. The computing device 100 may display user interfaces in the display 128 for users to effectively use the software tools for the software development project. Moreover, the application storage 110 may interface with the computing device 100 directly with the bus of the computing device 100 or via the network interface 126.

In one embodiment, the computing device 100 or an apparatus for effectively using software tools for a software development project includes the processor 102 and the memory 104 for temporarily storing a set of instructions. The set of instructions, when executed by the processor 102, causes the processor 102 to perform a method including displaying a tools plan view for a software development project having a plurality of tools categories associated with the software development project on the display 128 of the computing device 100. The plurality of tools categories is assigned with their respective weightages and natures and is divided into at least one software engineering criterion.

The method also includes generating a planned TEUI on the display 128 in response to a receipt of tools plan data and tools review data associated with the software development project. The method further includes generating an actual TEUI on the display 128 in response to a receipt of tools usage data and tools assessment data associated with the software development project. In one example embodiment, the tools plan data and the tools usage data are logged in by a project manager authenticated for the software development project. In another example embodiment, the tools review data and the tools assessment data are logged in by a tools manager authenticated for the software development project.

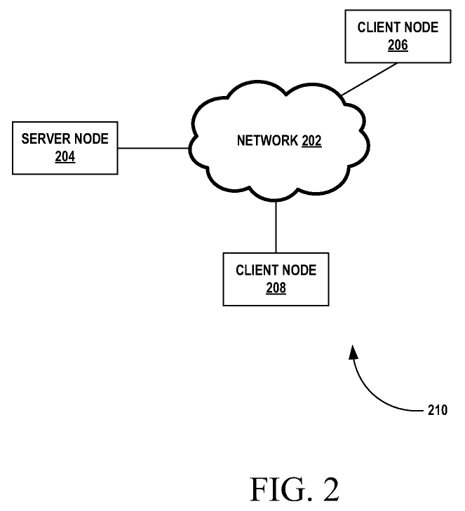

FIG. 2 illustrates an exemplary network environment 210 operable for practicing various embodiments of the present invention. The network environment 210 (e.g., a computer network of nodes) includes a server node 204 and client nodes 206 and 208. The server node 204 is coupled to the client nodes 206 and 208 via a network 202 (e.g., a communication network). In one example implementation, the client node 206 may be an electronic device accessed by the project manager and the client node 208 may be another electronic device accessed by the tools manager.

The server node 204 and the client nodes 206 and 208 can be implemented using the computing device 100 depicted in FIG. 1. The network interface 126 and the modem 124 of the computing device 100 enable the server node 204 to communicate with the client nodes 206 and 208 through the network 202. The network 202 may include Internet, intranet, LAN (Local Area Network), WAN (Wide Area Network), MAN (Metropolitan Area Network), and/or any other type of wireless or wired communication network. The communication facilities can support the distributed implementations of the present invention.

In the computer network of nodes 210 the server node 204 may provide the client nodes 206 and 208 with software components or products under a particular condition, such as a license agreement. The software components or products may include those for effectively using the software tools for the software development project as illustrated in FIG. 1. The server node 204 may send the clients 206 and 208 the software components or products under a specific license agreement.

In one embodiment, the computing device 100 or an apparatus for using software tools for a software development project includes the processor 102 and the memory 104 for temporarily storing a set of instructions. The set of instructions, when executed by the processor 102, causes the processor 102 to perform a method comprising displaying on the display 128 of the computing device 100 a tools plan view for a software development project having a plurality of tools categories associated with the software development project, wherein the plurality of tools categories is assigned with their respective weightages and natures. The method also includes generating a planned tools effective usage index (TEUI) on the display 128 in response to a receipt of tools plan data and tools review data associated with the software development project. The method further includes generating an actual TEUI on the display 128 in response to a receipt of tools usage data and tools assessment data associated with the software development project, wherein the tools plan data and the tools usage data are logged in by a project manager authenticated for the software development project; and wherein the tools review data and the tools assessment data are logged in by a tools manager authenticated for the software development project.

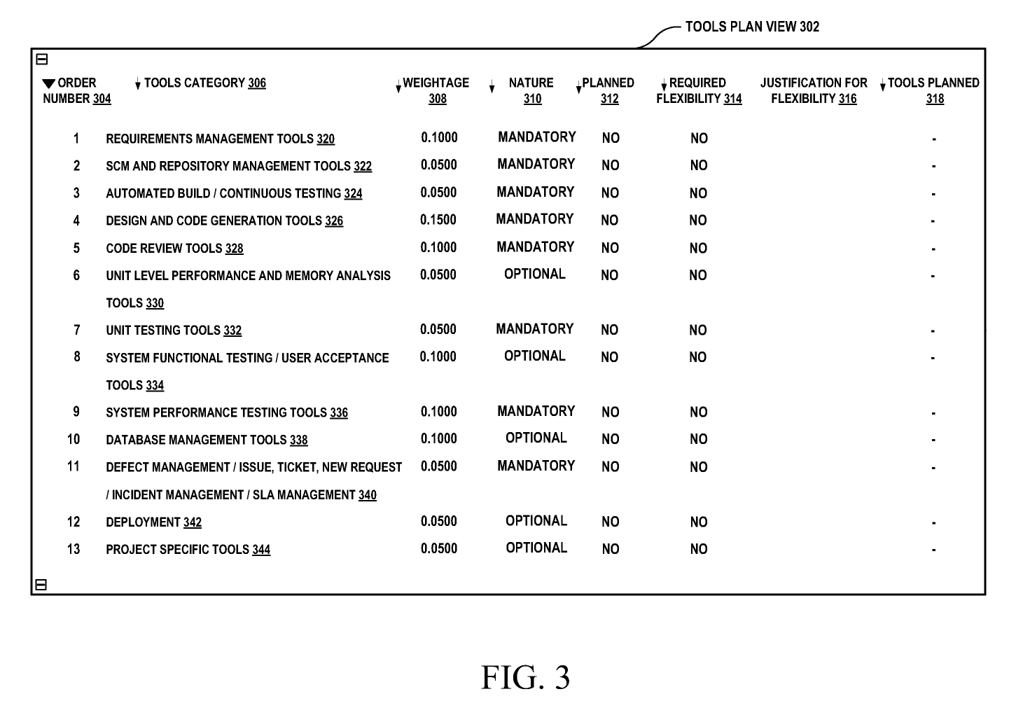

FIGS. 3, 5, 6, and 7 illustrate an exemplary tools plan view 302, according to one embodiment. Particularly, FIG. 3 illustrates the tools plan view 302 for a software development project having tools categories associated with the software development project. The tools plan view 302 of FIG. 3 includes an order number column 304, a tools category column 306, a weightage column 308, a nature column 310, a planned column 312, a require flexibility column 314, a justification for flexibility column 316 and a tools planned column 318.

The order number column 304 displays an order number associated with the tools categories in a recommended sequence. For example, the tools plan view 302 enables sorting of the tools categories in the tools category column 306 in the recommended sequence by clicking the order number column 304. As illustrated in FIG. 3, the tools category column 306 displays the tools categories including but not limited to requirements management tools 320, source code management (SCM) and repository management tools 322, automated build/continuous testing 324, design and code generation tools 326, code review tools 328, unit level performance and memory analysis tools 330, unit testing tools 332, system functional testing/user acceptance tools 334, system performance testing tools 336, database management tools 338, defect management/issue, ticket, new request/incident management/service level agreement (SLA) management 340, deployment 342 and project specific tools 344. In one embodiment, the tools categories are matched with different phases of the software development project.

Further, respective weightages and natures assigned to the tools categories are displayed in the weightage column 308 and the nature column 310 respectively. In one embodiment, the weightages may range from 0 to 100 percent and the nature may be mandatory or optional. It can be noted that, the tools categories which are mandatory in nature are to be compulsorily planned by the project manager authenticated for the software development project while the optional tools categories are planned at the discretion of the project manager.

The planned column 312 indicates whether or not the tools categories are planned by the project manager authenticated for the software development project. The require flexibility column 314 displays whether or not flexibility is required in case if a mandatory tools category includes no applicable software tools. Further, the justification for flexibility column 316 displays a reason(s) for non-applicability of the software tools. The tools planned column 318 displays software tools (e.g., coolgen, C+, C++, roadrunner, etc.) associated with each of the tools categories of the software development project.

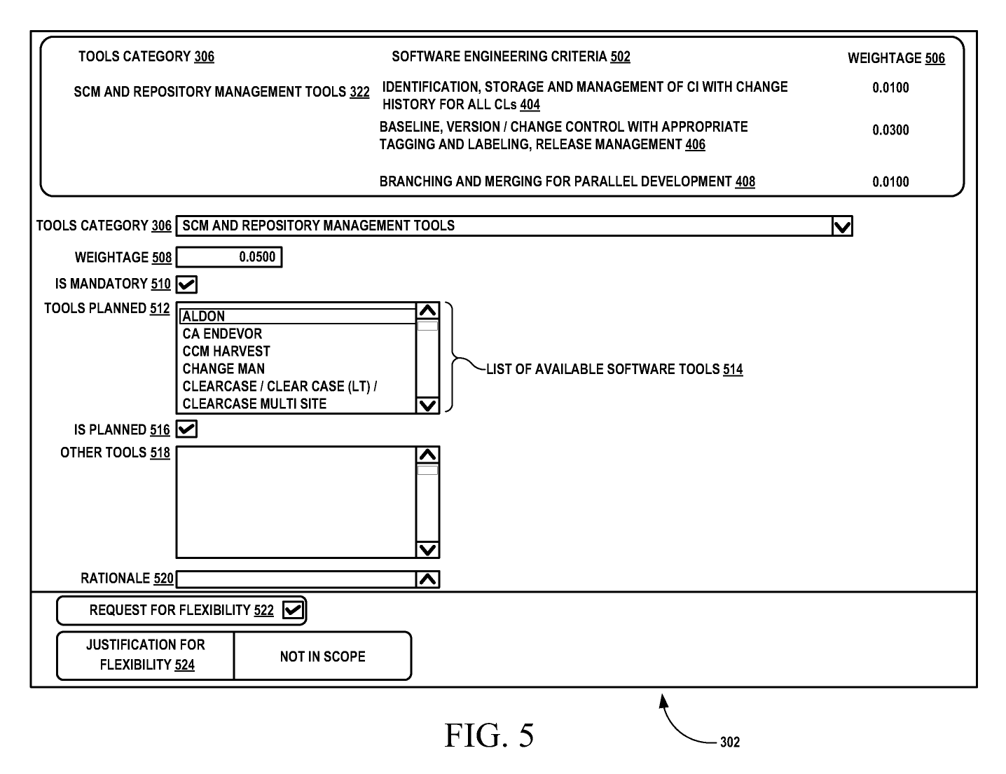

Further, FIG. 5 illustrates the tools plan view 302 where the SCM and repository management tools 322 and a list of corresponding software engineering criteria 502 are displayed. In one embodiment, the list of corresponding software engineering criteria 502 for the SCM and repository management tools 322 is displayed when the SCM and repository management tools 322 is accessed from the tools category column 306 by the project manager.

The tools plan view 302 of FIG. 5 also displays respective weightages associated with the software engineering criteria 502 in a weightage column 506. In one embodiment, the weightage associated with each of the tools categories is distributed among its software engineering criteria. For example, a weightage field 508 displays the weightage of the SCM and repository management tools 322 as 0.0500 which is distributed among its software engineering criteria 502 as 0.0100, 0.0300 and 0.0100 (e.g., in the weightage column 506).

Further, the tools plan view 302 of FIG. 5 includes a check box 510, a tools planned field 512, a check box 516, other tools field 518, a rationale field 520, a check box 522 and a justification for flexibility field 524. As illustrated, the check box 510 is checked which indicates that the SCM and repository management tools 322 is mandatory to be planned. The tools planned field 512 displays a list of available software tools 514 for the SCM and repository management tools 322. The project manager may select one or more software tools from the list of available software tools 514.

Further, the check box 516 is checked which indicates that the software tools are planned for the software development project. The project manager may also include other software tools through the other tools field 518. The rationale field 520 enables the project manager to provide a reason(s) for including the other software tools in the other tools field 518. The check box 522 may be checked by the project manager for logging in a flexibility request when one of the tools categories is mandatory but no software tool is appropriate for the one of the tools categories. In the example embodiment illustrated in FIG. 5, the check box 522 is checked which indicates that there are no applicable software tools for the SCM and repository management tools 322 and hence may require flexibility.

In one exemplary implementation, the flexibility request is forwarded to a user folder of the tools manager authenticated for the software development project. During a review of tools plan data logged in by the project manager, the tools manager may check for applicability of the one of tools categories and may grant the flexibility request if required. In one embodiment, if the flexibility request is granted by the tools manager, the one of the tools categories becomes optional. The tools plan view 302 of FIG. 5 also enables the project manager to provide a reason(s) for requiring flexibility in the justification for flexibility field 524.

The tools plan data may include one or more tools selected from the list of available software tools 514 and/or one or more software tools which are not available in the list available software tools 514. In one embodiment, a snapshot of the tools plan view 302 is generated based on the tools plan data logged in by the project manager. The snapshot of the tools plan view 302 is then stored in a database.

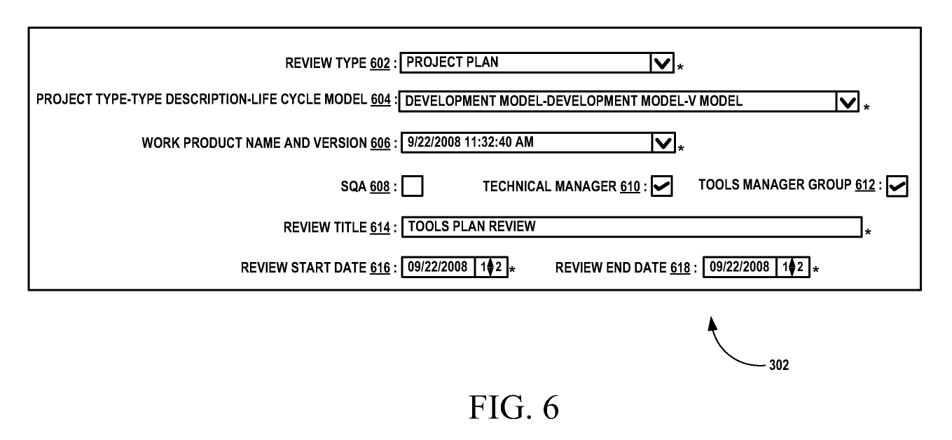

The tools plan view 302 of FIG. 6 illustrates a process of creating review for the tools manager and a technical manager. Particularly, the tools plan view 302 of FIG. 6 includes a review type field 602, a project type-type description-life cycle model field 604, a work product name and version field 606, check boxes 608, 610 and 612, a review title field 614, a review start date field 616 and a review end date field 618.

The review type field 602 enables the project manager to choose a review type (e.g., a project plan) associated with one of the tools categories. The project type-type description-life cycle model field 604 enables the project manager to select a model type (e.g., the snapshot of the tools plan view 302 from the database) associated with the one of the tools categories. Further, the project manager selects a work product name and version in the work product and version field 606. As illustrated, the check boxes 610 and 612 are checked which indicates that reviews for a technical manager and the tools manager are to be created.

The check box 608 is not checked which means that a review for a software quality assurance (SQA) representative is not to be created. Further, the project manager provides a review title (e.g., a tools plan review), a review start date and a review end date associated with the one of the tools categories in the review title field 614, the review start date field 616 and the review end date 618 respectively, as illustrated in FIG. 6. In one embodiment, upon creation of the review by the project manager, the snapshot of the tools plan view 302 is automatically forwarded for review to the user folder of the tools manager and to a user folder of the technical manager overseeing the software development project.

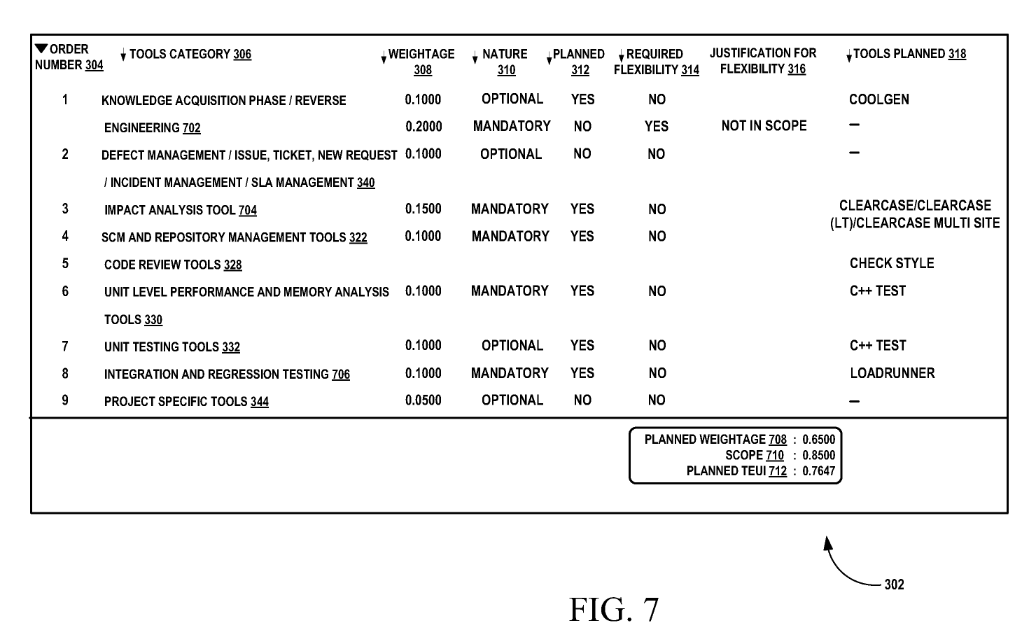

Further, FIG. 7 illustrates generating a planned TEUI 712 in response to a receipt of the tools plan data and tools review data associated with the software development project. Particularly, FIG. 7 illustrates the tools plan view 302 including the order number column 304, the tools category column 306, the weightage column 308, the nature column 310, the planned column 312, the require flexibility column 314, the justification for flexibility column 316 and the tools planned column 318.

The tools category column 306 displays the tools categories such as knowledge acquisition phase/reverse engineering 702, impact analysis tools 704, integration and regression testing 706 along with the other tools categories such as the defect management/issue, ticket, new request/incident management/SLA management 340, the SCM and repository management tools 322, the code review tools 328, the unit level performance and memory analysis tools 330, the unit testing tools 332 and the project specific tools 344.

Further, respective weightages assigned to the tools categories are listed in the weightage column 308. As illustrated, some of the tools categories are listed as mandatory in the nature column 310. Also, the planned column 312 displays which of the tools categories are planned and not planned and the require flexibility column 314 displays which of the tools categories require flexibility, respectively.

In addition, the software tools associated with the planned tools categories are listed in the tools planned column 318. In accordance with the above mentioned embodiments, the planned TEUI 712 is generated by dividing a sum of weightages of all of the tools categories listed as planned (e.g., a planned weightage 708) by a sum of weightages of all of the tools categories listed as planned and weightages of all of the tools categories listed as mandatory but not planned (e.g., a scope 710). In the example embodiment illustrated in FIG. 7, the planned weightage 708 is 0.6500 and the scope 710 is 0.8500. Further, the planned TEUI 712 calculated by dividing the planned weightage 708 by the scope 710 is 0.7647.

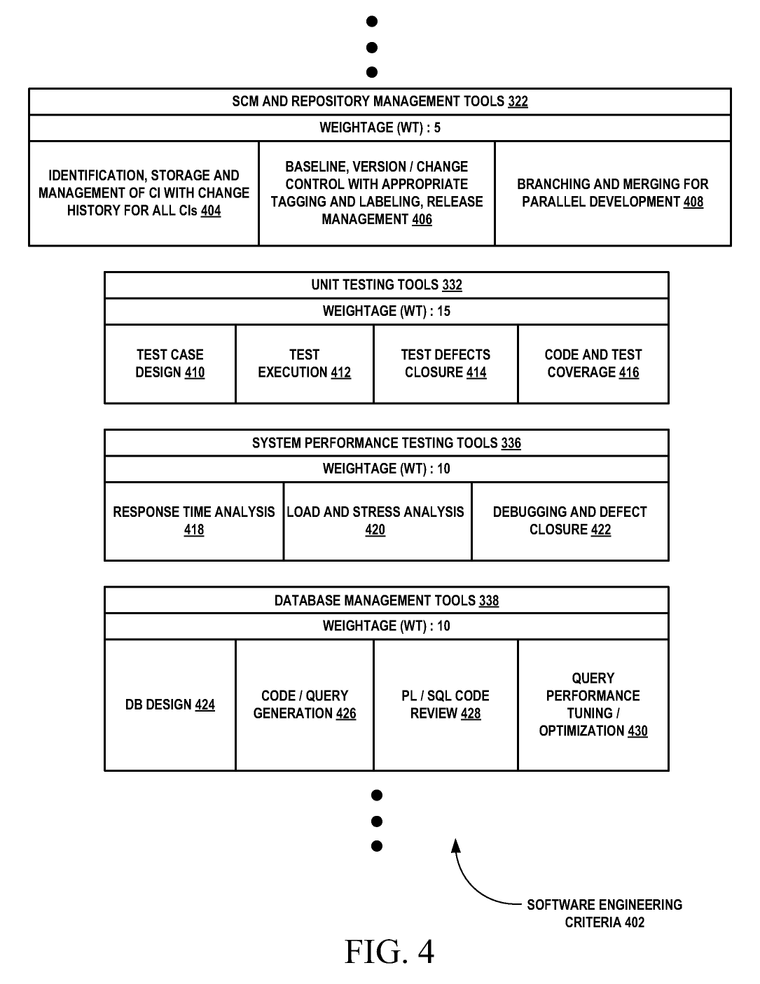

FIG. 4 illustrates exemplary software engineering criteria 402 for the tools categories, according to one embodiment. It is appreciated that, each of the tools categories is divided into one or more software engineering criteria to ensure all the applicable aspects/best practices of each software tool are used in the software development project. Particularly, FIG. 4 illustrates exemplary software engineering criteria 402 for the SCM and repository management tools 322, the unit testing tools 332, the system performance testing tools 336, the database management tools 338, and so on. As illustrated, the software engineering criteria 402 for the SCM and repository management tools 322 includes identification, storage and management of coded information (CI) with change history for all CIs 404, baseline, version/change control with appropriate tagging and labeling, release management 406 and branching and merging for parallel development 408.

Corresponding software engineering criteria 402 for the unit testing tools 332 includes test case design 410, test execution 412, test defects closure 414 and code and test coverage 416. Corresponding software engineering criteria 402 for the system performance testing tools 336 includes response time analysis 418, load and stress analysis 420 and debugging and defect closure 422. Also, corresponding software engineering criteria 402 for the database management tools 338 includes database (DB) design 424, code/query generation 426, procedural language/structured query language (PL/SQL) code review 428 and query performance tuning/optimization 430.

In addition, FIG. 4 illustrates the respective weightages associated with the tools categories. For example, the SCM and repository management tools 322 is assigned a weightage of 5, the unit testing tools 332 is assigned a weightage of 15, the system performance testing tools 336 is assigned a weightage of 10 and the database management tools 338 is assigned a weightage of 10. Further, each of the software engineering criteria 402 associated with the tools categories is assigned a respective weightage.

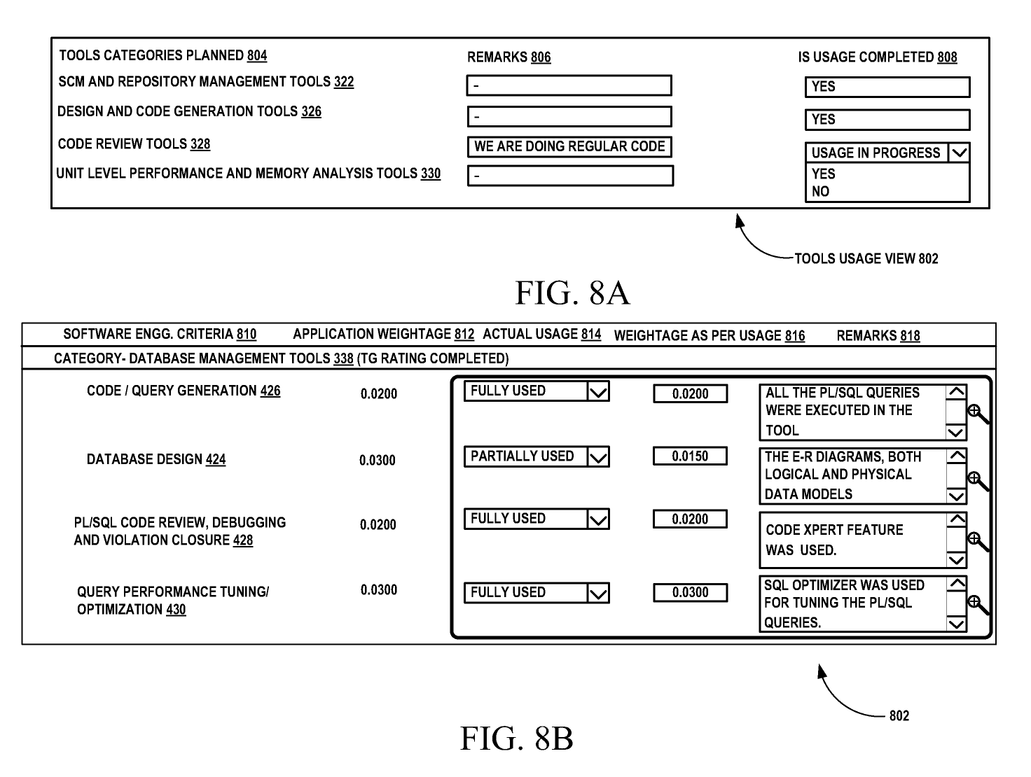

FIGS. 8A, 8B, 9A, 9B, and 10 illustrate an exemplary tools usage view 802, according to one embodiment. Particularly, FIG. 8A illustrates a tools categories planned column 804, a remarks column 806 and a is usage completed column 808. The tools categories planned column 804 lists out all the tools categories that are planned by the project manager. For example, the tools categories planned column 804 includes the SCM and repository management tools 322, the design and code generation tools 326, the code review tools 328 and the unit level performance and memory analysis tools 330.

The remarks column 806 displays remarks associated with usage of the software tools of the tools categories listed in the tools categories planned column 804. In the example embodiment illustrated in FIG. 8A, the remark associated with the usage of the code review tools 328 includes ‘we are doing regular code’. Further, the is usage column completed 808 displays a status associated with the usage of the software tools. For example, the status may include ‘yes’, ‘no’, ‘usage in progress’, ‘phase yet to start’, etc., which can be selected by the project manager using a drop down menu. The status ‘yes’ refers to completion of usage of at least one software engineering criterion against a tools category for module/project/iteration. The status ‘usage in progress’ refers to start of usage of a software tool.

In the example embodiment illustrated in FIG. 8A, the status associated with the SCM and repository management tools 322 and the design and code generation tools 326 is ‘yes’ and the status associated with the code review tools 328 is ‘usage in progress’. In one embodiment, a request for tools assessment data is forwarded to a user account of the tools manager in response to a receipt of the tools usage data logged in by the project manager.

Particularly, FIG. 8B illustrates rating and remarks associated with the software tools. It can be noted that, the tools manager assess and provides a rating to only those tools categories that have a usage completed status ‘yes’. For example, the tools manager performs a detailed health check of the software tools being used against the tools categories. Further, the usage of the software tool is assessed against a software engineering criterion associated with the tools categories. The rating may include ‘fully used’, ‘partially used’, or ‘not used’. It can be noted that, if the tools assessment data of the software engineering criterion is rated as ‘partially used’ by the tools manager, then a revisit flag for the software engineering criterion may be forwarded to the user account of the project manager.

As illustrated, the tools usage view 802 includes a software engineering criteria column 810, an applicable weightage column 812, an actual usage column 814, a weightage as per usage column 816 and a remarks column 818. The software engineering criteria column 810 displays software engineering criteria associated with the planned tools category that has status ‘yes’. The applicable weightage column 812 displays respective applicable weightages for each completed software engineering criteria. The actual usage column 814 displays a rating associated with each of the software engineering criteria. The weightage as per usage column 816 displays respective weighatges for the each completed software engineering criteria assigned based on the tools assessment data. The remarks column 818 displays remarks associated with the usage of the software tools.

In the example embodiment illustrated in FIG. 8B, the software engineering criteria column 810 displays the software engineering criteria associated with the database management tools 338 as code/query generation 426, database design 424, PL/SQL code review, the debugging and violation closure 428 and query performance tuning/optimization 430. Further, the applicable weightage column 812 displays the applicable weightage of the code/query generation 426, the database design 424, the PL/SQL code review, the debugging and violation closure 428 and the query performance tuning/optimization 430 as 0.0200, 0.0300, 0.0200 and 0.0300 respectively. The actual usage column 814 displays rating as ‘fully used’, ‘partially used’, ‘fully used’ and ‘fully used’ for the code/query generation 426, the database design 424, the PL/SQL code review, the debugging and violation closure 428 and the query performance tuning/optimization 430 respectively.

Since the software engineering criteria such as the code/query generation 426, the debugging and violation closure 428 and the query performance tuning/optimization 430 are rated as ‘fully used’, respective weightage as per usage is similar to the respective applicable weightage (e.g., 0.0200, 0.0200 and 0.0300 respectively). Also, the weightage as per usage column 816 displays weightage as per usage as 0.0150 for the database design 424 since the database design 424 is rated as ‘partially used’.

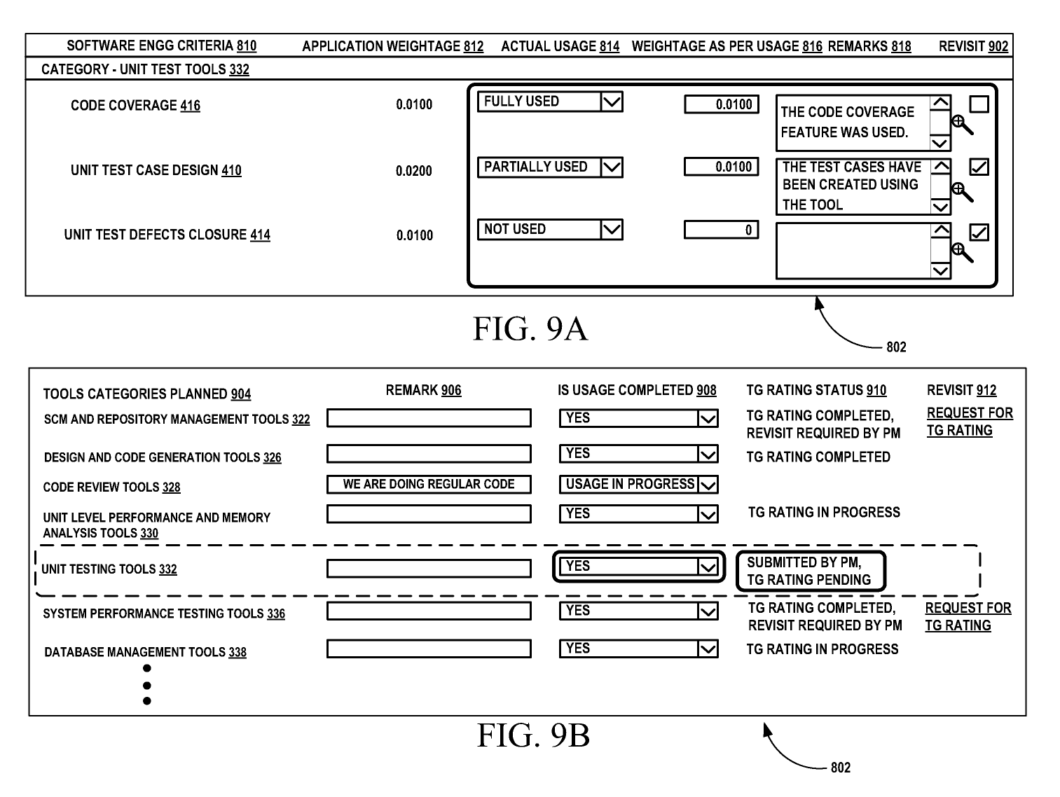

Further, FIG. 9A illustrates the tools usage view 802 with a revisit column 902. In one embodiment, the tools manager may check a particular software engineering criterion for revisit using the check boxes in the revisit column 902. For example, revisiting of the particular software engineering criterion includes re-evaluating the software tools usage in future with respect to the checked software engineering criterion. The revisit may be needed due to the fact that the usage of the software tools in the software development project is not done effectively or is not in-line with the checked software engineering criterion, the usage of the software tools in the software development project is still not complete but the software tool may have been used effectively, or both. It can be noted that, the tools manager may provide any rating to the software tools that require revisit.

Further, if a particular software tool has to be revisited against the checked software engineering criterion, then a link against that software tool is available in a tracking page for the project manager. The project manager clicks the link and proceeds with the usage of the software tool as suggested by the tools manager. Also, the software tool is resubmitted to the tools manager for a fresh rating as illustrated in FIG. 9B. The tools manager then reevaluates the software tool usage and provides the rating. If the tools manager is still not satisfied with the software tool usage, a revisit may be again demanded.

Particularly, FIG. 9B illustrates the tools usage view 802 that includes a tools categories planned column 904, a remark column 906, a is usage completed column 908, a tools group (TG) rating status 910 and a revisit column 912. The tools planned column 904 displays the tools categories such as the SCM and repository management tools 322, the design and code generation tools 326, the code review tools 328, the unit level performance and memory analysis tools 330, the unit testing tools 332, the system performance testing tools 336 and the database management tools 338.

The remark column 906 displays remarks associated with the usage of the software tools listed in the tools categories planned column 904. The is usage completed column 908 displays statuses associated with the usage of the software tools. The TG rating status column 910 displays a rating status of software tool usage for every tools category that has been marked as ‘yes’ in the ‘is usage completed column’ 908. As illustrated, the TG rating status may include ‘TG rating completed, revisit required by project manager’, ‘TG rating completed’, ‘TG rating in progress’, ‘submitted by project manager, TG rating pending’, etc. It can be noted that, when the ‘TG rating status’ is ‘submitted by project manager, rating pending with TG’, then the ‘is usage completed column’ 908 is available for editing. Further, the revisit column 912 displays a request for revisit.

For example, the above mentioned TG rating status interprets that the tools manager has provided rating for all the software engineering criteria and has checked at least one of the software engineering criterion for ‘revisit’, the software tools usage rating against all the software engineering criteria is completed for the entire course of the software development project, the software tools usage rating process has been initiated by the tools manager and is in progress, and the project manager has resubmitted the software tools for rating and the tools manager is yet to initiate the software tools usage rating process, respectively.

In accordance with the above mentioned embodiments, when a respective tools usage data is updated by the project manager, a request for new tools assessment data is automatically forwarded to the user account of the tools manager. In the example embodiment illustrated in FIG. 9B, the request for new tools assessment data is automatically forwarded to the user account of the tools manager when the tools usage data associated with the unit testing tools 332 is updated by the project manager in the is usage completed column 908.

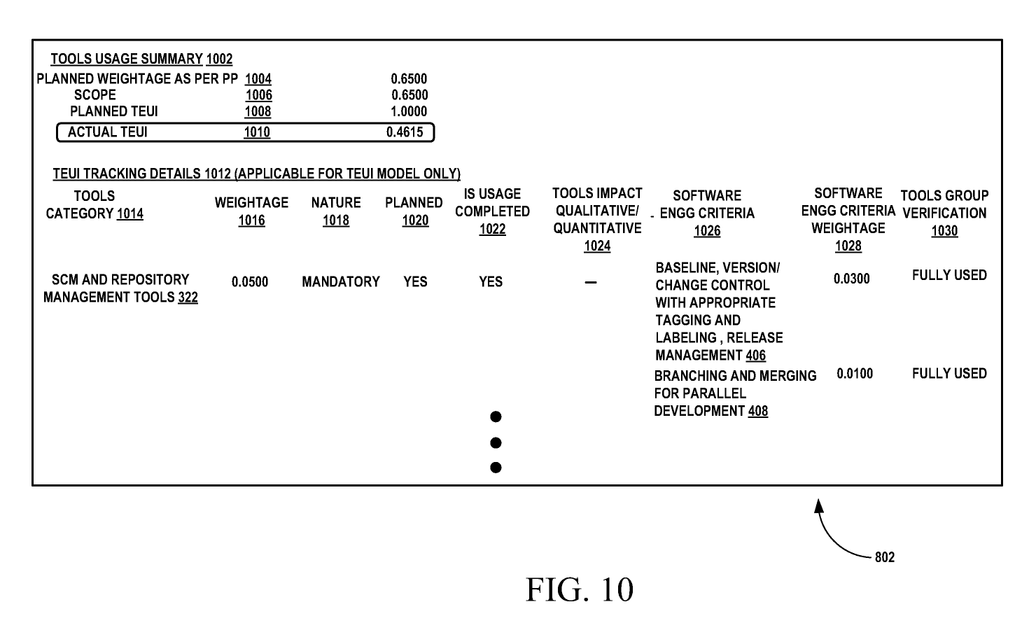

Further, FIG. 10 illustrates the tools usage view 802 that displays a tools usage summary 1002. Particularly, the tools usage view 802 illustrates planned weight as per project plan (PP) 1004, a scope 1006, a planned TEUI 1008, an actual TEUI 1010 and a TEUI tracking details 1012. In one embodiment, the actual TEUI 1010 is generated in response to a receipt of the tools usage data and the tools assessment data associated with the software development project. Further, the actual TEUI 1010 is generated by dividing a sum of weightages of completed software engineering criteria of the tools categories by a sum of weightages of all of the plurality of tools categories listed as planned and weightages of all of the software tools listed as mandatory but not planned.

Further, the TEUI tracking details 1012 includes a tools category column 1014, weightage column 1016, a nature column 1018, a planned column 1020, a is usage completed column 1022, a tools impact qualitative/quantitative column 1024, a software engineering criteria column 1026, a software engineering criteria weightage column 1028 and a tools group verification column 1030.

In the example embodiment illustrated in FIG. 10, the tools usage summary 1002 displays the planned weightage as per PP 1004 as ‘0.6500’, the scope 1006 as ‘0.6500’, the planned TEUI 1008 as ‘1.0000’ and the actual TEUI 1010 as ‘0.4615’. Further, the TEUI tracking details 1012 displays TEUI tracking details associated with the SCM and repository management tools 322. The TEUI tracking details 1012 displays the weightage as ‘0.0500’, the nature as ‘mandatory’, is planned for the software development project, and the usage completed status as ‘yes’.

Further, the software engineering criteria column 1026 of the TEUI tracking details 1012 displays the software engineering criteria as ‘baseline, version/change control with appropriate tagging and labeling, release management 406’ and ‘branching and merging for parallel development 408’. The software engineering criteria weightage column 1028 display the respective weightage for the above software engineering criteria as ‘0.0300’ and ‘0.0100’ respectively. Moreover, the tools group verification column 1030 displays a verification rating associated with both the above software engineering criteria as ‘fully used’.

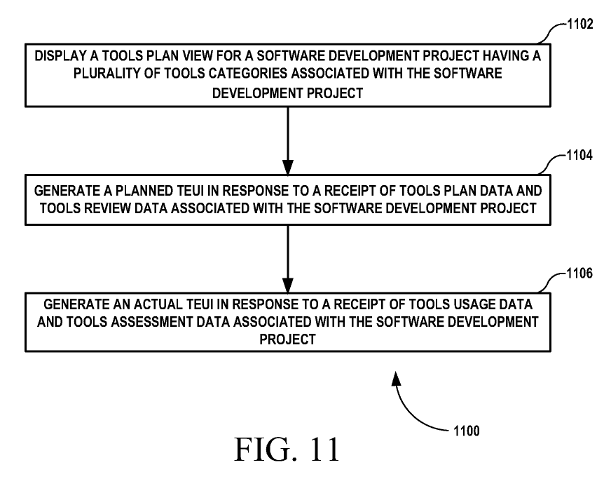

FIG. 11 is a process flow chart of an exemplary method 1100 for effectively using software tools employed in a software development project, according to one embodiment. In operation 1102, a tools plan view for a software development project having a plurality of tools categories associated with the software development project is displayed on a display of a computing device. In one example embodiment, the plurality of tools categories is assigned with their respective weightages and natures.

In operation 1104, a planned TEUI is generated on the display in response to a receipt of tools plan data and tools review data associated with the software development project. In operation 1106, an actual TEUI is generated on the display in response to a receipt of tools usage data and tools assessment data associated with the software development project. In one embodiment, the tools plan data and the tools usage data are logged in by a project manager authenticated for the software development project. In another embodiment, the tools review data and the tools assessment data are logged in by a tools manager authenticated for the software development project.

Moreover, in one example embodiment, a computer readable medium for effectively using the software tools for the software development project has instructions that, when executed by a computer, cause the computer to perform the method illustrated in FIG. 11.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present disclosure is not intended to be limited to the embodiments shown herein but is to be accorded the widest scope consistent with the principles and features disclosed herein.

What is claimed is:

1. A method, implemented in a computing device, of effectively using software tools for a software development project, comprising:
displaying on a display of the computing device a tools plan view for a software development project having a plurality of tools categories associated with the software development project, wherein the plurality of tools categories is assigned with their respective weightages and natures;
generating a planned tools effective usage index (TEUI) on the display in response to a receipt of tools plan data and tools review data associated with the software development project; and
generating an actual TEUI on the display in response to a receipt of tools usage data and tools assessment data associated with the software development project, wherein the tools plan data and the tools usage data are logged in by a project manager authenticated for the software development project; and wherein the tools review data and the tools assessment data are logged in by a tools manager authenticated for the software development project.

2. The method of claim 1, wherein the plurality of tools categories are matched with different phases of the software development project.

3. The method of claim 1, wherein the weightages range from 0 to 100 percent, and the natures comprise mandatory and optional.

4. The method of claim 1, wherein each of the plurality of tools categories is further divided into at least one software engineering criterion.

5. The method of claim 4, wherein each of the at least one software engineering criterion is assigned with a respective weightage.

6. The method of claim 1, wherein the displaying the tools plan view further comprises:
displaying a list of software engineering criteria if one of the plurality of tools categories is accessed; and
displaying a list of available software tools for the one of the plurality of tools categories.

7. The method of claim 6, wherein the generating the planned TEUI comprises:
generating a snapshot of the tools plan view based on the tools plan data; and
automatically forwarding the snapshot of the tools plan view to a user folder of the tools manager and to a user folder of a technical manager overseeing the software development project.

8. The method of claim 7, wherein the tools plan data comprises one of: at least one software tool selected by the project manager from the list of available software tools and at least one other software tool logged in by the project manager which is not available in the list of available tools.

9. The method of claim 8, wherein the tools plan data further comprises a flexibility request logged in by the project manager and forwarded to the user folder of the tools manager when the one of the plurality of tools categories is mandatory but no software tool is appropriate for the one of the plurality of tools categories.

10. The method of claim 9, wherein the one of the plurality of tools categories becomes optional if the flexibility request is granted by the tools manager.

11. The method of claim 1, wherein the planned TEUI index equals a sum of weightages of all of the plurality of tools categories listed as planned divided by a sum of weightages of all of the plurality of tools categories listed as planned and weightages of all of the plurality of tools categories listed as mandatory but not planned.

12. The method of claim 1, wherein the generating the actual TEUI comprises forwarding a request for the tools assessment data to a user account of the tools manager in response to a receipt of the tools usage data logged in by the project manager.

13. The method of claim 12, wherein the actual TEUI is obtained by dividing a sum of weightages of completed software engineering criteria of the plurality of tools categories by a sum of weightages of all of the plurality of tools categories listed as planned and weightages of all of the plurality of tools listed as mandatory but not planned.

14. The method of claim 13, wherein a respective weightage for each completed software engineering criterion is assigned based on the tools assessment data.

15. The method of claim 12, wherein the generating the actual TEUI further comprises forwarding a revisit flag for a software engineering criterion to an user account of the project manager when tools assessment data of the software engineering criterion is rated as partially used by the tools manager.

16. The method of claim 15, wherein a request for new tools assessment data is automatically forwarded to the user account of the tools manager when a respective tools usage data is updated by the project manager.

17. A computer readable medium having instructions that, when executed by a computer, cause the computer to perform a method of effectively using software tools for a software development project comprising:
displaying on a display of the computing device a tools plan view for a software development project having a plurality of tools categories associated with the software development project, wherein the plurality of tools categories is assigned with their respective weightages and natures;
generating a planned tools effective usage index (TEUI) on the display in response to a receipt of tools plan data and tools review data associated with the software development project; and
generating an actual TEUI on the display in response to a receipt of tools usage data and tools assessment data associated with the software development project, wherein the tools plan data and the tools usage data are logged in by a project manager authenticated for the software development project; and wherein the tools review data and the tools assessment data are logged in by a tools manager authenticated for the software development project.

18. The computer readable medium of claim 17, wherein each of the plurality of tools categories is further divided into at least one software engineering criterion.

19. An apparatus for effectively using software tools for a software development project, comprising:
a processor; and
a memory for temporarily storing a set of instructions, when executed by the processor, causes the processor to perform a method comprising:
displaying on a display of a computing device a tools plan view for a software development project having a plurality of tools categories associated with the software development project, wherein the plurality of tools categories is assigned with their respective weightages and natures;
generating a planned tools effective usage index (TEUI) on the display in response to a receipt of tools plan data and tools review data associated with the software development project; and
generating an actual TEUI on the display in response to a receipt of tools usage data and tools assessment data associated with the software development project, wherein the tools plan data and the tools usage data are logged in by a project manager authenticated for the software development project; and wherein the tools review data and the tools assessment data are logged in by a tools manager authenticated for the software development project.

20. The apparatus of claim 19, further comprising an application storage storing the set of instructions.
